(19) United States
(12) Patent Application Publication
(10) Pub. No.: US 2026/0138478 A1
(43) Pub. Date: May 21, 2026

(54) Battery Charging Wheels Device

(71) Applicant: Enrique Brumaghin, Kingsbury, TX (US)

(72) Inventor: Enrique Brumaghin, Kingsbury, TX (US)

(21) Appl. No.: 19/211,489

(22) Filed: May 19, 2025

Related U.S. Application Data
(60) Provisional application No. 63/720,790, filed on Nov. 15, 2024.

(51) Int. Cl. B60L 53/57; B60L 50/60; H02K 7/18

(52) U.S. Cl. CPC B60L 53/57; B60L 50/60; H02K 7/1846

(57) ABSTRACT

A battery charging wheels device is disclosed, which is a supplemental charging device for electric vehicles. The battery charging wheels device comprises a rotating winding portion located on a vehicle wheel, a corresponding stationary winding portion located on the vehicle axle, a power supply, and a power cable connected to the battery. When in motion, the rotating winding portion and the stationary winding portion would create the electric field, like a generator, allowing for the device to produce electricity for the battery. In this manner, the vehicle would be constantly charging while in motion, thus increasing range and eliminating the time needed to charge the vehicle at home or on the road.

### CROSS-REFERENCE TO RELATED APPLICATION

The present application claims priority to, and the benefit of, U.S. Provisional Application No. 63/720,790, which was filed on Nov. 15, 2024, and is incorporated herein by reference in its entirety.

### FIELD OF THE INVENTION

The present invention relates generally to the field of battery charging wheels devices. More specifically, the present invention relates to a magnet and stationary winding system that attaches to vehicle wheels to facilitate electrical power generation when the vehicle is in motion. Accordingly, the present invention makes specific reference thereto. Nonetheless, it is to be appreciated that aspects of the present invention are also equally applicable to other like applications, devices, and methods of manufacture.

### BACKGROUND

By way of background, this invention relates to improvements in battery charging wheels devices. Generally, most vehicles are powered by gas, a non-renewable resource that creates environmental pollution. However, some vehicle owners have shifted to purchasing electric vehicles. While electric vehicles are efficient, the vehicle's battery range may only allow the vehicle to travel short distances. Further, potential power outages can cause recharging issues, or if people cannot locate a charging station while on the road, they may not be able to travel. Thus, taking long trips with an electric vehicle requires planning to ensure there are electric vehicle charging stations along the routes.

Accordingly, there is a demand for an improved battery charging wheels device that extends the range and mileage of an electric vehicle. More particularly, there is a demand for a battery charging wheels device that generates power via wheel rotation.

Therefore, there exists a long-felt need in the art for a battery charging wheels device that provides users with a magnet and stationary winding system that attaches to vehicle wheels to facilitate electrical power generation when the vehicle is in motion. There is also a long-felt need in the art for a battery charging wheels device that allows vehicle owners to maintain supplemental power to their electric vehicle without having to frequently stop for charging stations. Further, there is a long-felt need in the art for a battery charging wheels device that reduces expenses associated with charging electric vehicles at home or while traveling. Moreover, there is a long-felt need in the art for a device that extends the range of an electric vehicle's battery with ease and convenience. Further, there is a long-felt need in the art for a battery charging wheels device that is a supplemental charging device for electric vehicles. Finally, there is a long-felt need in the art for a battery charging wheels device that, when in motion, the rotating portion and the locked portion would create an electric field, like a generator.

The subject matter disclosed and claimed herein, in one embodiment thereof, comprises a battery charging wheels device. The device is a supplemental charging device for electric vehicles. The battery charging wheels device comprises a rotating winding portion located on a vehicle wheel, a corresponding stationary winding portion located on the vehicle axle, a power supply, and a power cable connected to the battery. The rotating winding portion would fit around the stationary winding portion, and both winding portions would be comprised of copper to efficiently create an electrical field. Specifically, when in motion, the rotating winding portion and the stationary winding portion would create the electric field, like a generator, allowing for the device to produce electricity for the battery. In this manner, the vehicle would be constantly charging while in motion, thus increasing range and eliminating the time needed to charge the vehicle at home or on the road.

In this manner, the battery charging wheels device of the present invention accomplishes all of the foregoing objectives and provides users with a device that extends the range and mileage of an electric vehicle. The device is a rotating winding portion and a corresponding stationary winding portion which act to create an electrical field. The device would be constantly charging while in motion.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a battery charging wheels device. The device is a supplemental charging device for electric vehicles. The battery charging wheels device comprises a rotating winding portion located on a vehicle wheel, a corresponding stationary winding portion located on the vehicle axle, a power supply, and a power cable connected to the battery. Specifically, when in motion, the rotating winding portion and the stationary winding portion would create an electric field, like a generator, allowing for the device to produce electricity for the battery. In this manner, the vehicle would be constantly charging while in motion, thus increasing range and eliminating the time needed to charge the vehicle at home or on the road.

Generally, for the most part, details regarding basic automotive engineering, electrical generators, magnets, electromagnets, coils, stators, rotators, batteries, and the like have been omitted inasmuch as such details are not considered necessary to obtain a complete understanding of the present invention, and are considered to be within the skills of persons of ordinary skill in the relevant art.

In one embodiment, the battery charging wheels device utilizes rotating and stationary winding portions to charge a battery of an electric vehicle. The rotating and stationary winding portions are dynamic and generate power via wheel rotation of the electric vehicle. Specifically, the rotating and stationary winding portions operate by the motion of a vehicle. The rotating and stationary winding portions operate as a typical generator to create an electric field, allowing for the device to produce electricity for the battery.

In one embodiment, the rotating winding portion is located on a vehicle wheel, at an interior of the wheel, and contacts the wheel, such that rotation of the wheel causes rotation of the rotating winding portion. Typically, the rotating winding portion is comprised of copper windings to efficiently create the electric field when rotating. Further, the corresponding stationary winding portion is located on the vehicle axle. The stationary winding portion would comprise a plurality of magnets integrated into it. In use, the rotating winding portion would fit around the stationary winding portion, such that the rotating winding portion rotates around the stationary winding portion to create the electric field. Thus, the rotating winding portion is rotated by the vehicle wheel, such that as the vehicle wheel rotates, the rotating winding portion rotates around the stationary winding portion, which has a plurality of integrated magnets, to create power/charge, which is then transmitted to the battery.

In one embodiment, the power/charge is transmitted to the battery via a power cable connected from the device to the battery. The power/charge created by the device can be transmitted via any suitable transmitting means as is known in the art.

In one embodiment, a power supply, such as the electric vehicle's motor and drivetrain, act to power the electric vehicle and rotate the wheels. Specifically, when in motion, the rotating winding portion and the stationary winding portion would create the electric field, like a generator, allowing for the device to produce electricity for the battery.

In one embodiment, the battery charging wheels device can be secured to two of the four vehicle wheels to provide power to the battery. Specifically, the rotating and stationary winding portions would be in communication with the battery to charge it. Typically, an electrical conduit, such as a power cable, would transfer the power from the device to the battery, to charge it for use.

In another embodiment, the battery charging wheels device can be secured to all four vehicle wheels to provide additional power to the battery. When the rotating winding portions are secured to all four wheels, they are positioned on an interior wheel, and the stationary winding portions are positioned on the wheel axles.

In one embodiment, the battery charging wheels device then transfers power to the battery for powering the vehicle. The battery is charged by the rotating and stationary winding portions, which create an electric field as the wheels rotate during use. In operation, when the electric vehicle moves, the wheels rotate. This rotation causes the rotating winding portion to spin around the stationary winding portion, which includes integrated magnets, to generate power. This charge/power transmits from the rotating and stationary winding portions through a power cable and to the battery, thus recharging the battery. In this manner, an electric vehicle is constantly under recharge during the operation of the vehicle. Thus, the generation of electricity from the rotating and stationary winding portions result in a decrease in the rate of drain on the electric vehicle's battery, thereby increasing the electric vehicle's range, and decreasing the amount of recharge time needed between electric vehicle uses.

In another embodiment, the power from the battery is then transferred to the vehicle's motor to drive/power the vehicle. Typically, charge comes into the battery from one side and leaves the battery from the other side. Charge from the battery is then sent via an electrical conduit/power cable to the electric motor to power the vehicle.

It may be appreciated that the generation of electricity from the rotating and stationary winding portions result in a decrease in the rate of drain on the electric vehicle's battery, thereby increasing the electric vehicle's range, and decreasing the amount of recharge time needed between electric vehicle uses. Thus, a user is freed from the problems associated with fossil fuels without being subjected to the traditionally long charge times, short ranges, and expensive home infrastructure usually associated with electric vehicles.

In yet another embodiment, the battery charging wheels device comprises a plurality of indicia.

In yet another embodiment, a method of charging an electric vehicle via wheel rotation is disclosed. The method includes the steps of providing a battery charging wheels device comprising a rotating winding portion and a stationary winding portion. The method also comprises securing the rotating winding portion to a vehicle wheel. Further, the method comprises securing the stationary winding portion to a vehicle axle. The method also comprises fitting the rotating winding portion around the stationary winding portion, such that rotation creates an electric field. The method comprises transferring the power from the winding portions to a vehicle battery via a power cable connected to the battery to charge the battery. Finally, the method comprises generating power for the electric vehicle via rotation of the vehicle wheels.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the battery charging wheels device of the present invention showing the device applied to an electric vehicle in accordance with the disclosed architecture;

FIG. 2 illustrates a perspective view of one embodiment of the battery charging wheels device of the present invention showing the stationary and rotating winding portions in accordance with the disclosed architecture;

FIG. 3 illustrates a perspective view of one embodiment of the battery charging wheels device of the present invention showing how electricity is generated and transferred to a battery in accordance with the disclosed architecture;

FIG. 4 illustrates a perspective view of one embodiment of the battery charging wheels device of the present invention showing the device installed within a vehicle in accordance with the disclosed architecture;

FIG. 5 illustrates a perspective view of one embodiment of the battery charging wheels device of the present invention showing the device in use in accordance with the disclosed architecture; and

FIG. 6 illustrates a flowchart showing the method of charging an electric vehicle via wheel rotation in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a battery charging wheels device that provides users with a magnet and stationary winding system that attaches to vehicle wheels to facilitate electrical power generation when the vehicle is in motion. There is also a long-felt need in the art for a battery charging wheels device that allows vehicle owners to maintain supplemental power to their electric vehicle without having to frequently stop for charging stations. Further, there is a long-felt need in the art for a battery charging wheels device that reduces expenses associated with charging electric vehicles at home or while traveling. Moreover, there is a long-felt need in the art for a device that extends the range of an electric vehicle's battery with ease and convenience. Further, there is a long-felt need in the art for a battery charging wheels device that is a supplemental charging device for electric vehicles. Finally, there is a long-felt need in the art for a battery charging wheels device that, when in motion, the rotating portion and the locked portion would create an electric field, like a generator.

The present invention, in one exemplary embodiment, is a novel battery charging wheels device. The battery charging wheels device comprises a rotating winding portion located on a vehicle wheel, a corresponding stationary winding portion located on the vehicle axle, a power supply, and a power cable connected to the battery. The rotating winding portion would fit around the stationary winding portion, and both winding portions would be comprised of copper to efficiently create an electrical field. Specifically, when in motion, the rotating winding portion and the stationary winding portion would create the electric field, like a generator, allowing for the device to produce electricity for the battery. The present invention also includes a novel method of charging an electric vehicle via wheel rotation. The method includes the steps of providing a battery charging wheels device comprising a rotating winding portion and a stationary winding portion. The method also comprises securing the rotating winding portion to a vehicle wheel. Further, the method comprises securing the stationary winding portion to a vehicle axle. The method also comprises fitting the rotating winding portion around the stationary winding portion, such that rotation creates an electric field. The method comprises transferring the power from the winding portions to a vehicle battery via a power cable connected to the battery to charge the battery. Finally, the method comprises generating power for the electric vehicle via rotation of the vehicle wheels.

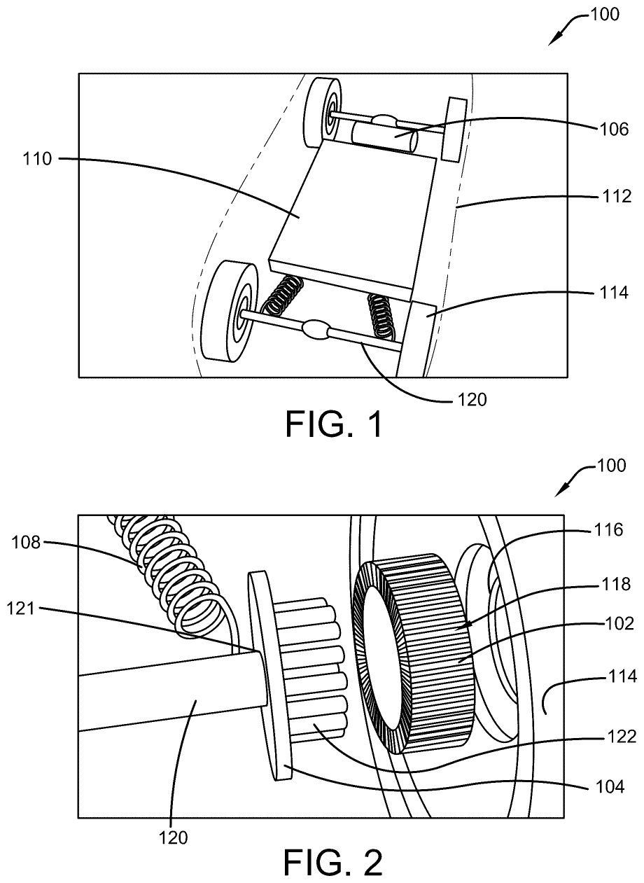

Referring initially to the drawings, FIG. 1 illustrates a perspective view of one embodiment of the battery charging wheels device 100 of the present invention. In the present embodiment, the battery charging wheels device 100 is an improved battery charging wheels device 100 that provides a supplemental charging device for electric vehicles 112. Specifically, the battery charging wheels device 100 comprises a rotating winding portion 102, a corresponding stationary winding portion 104, a power supply 106, and a power cable 108 connected to the vehicle battery 110. The device 100 essentially increases the distance an electric vehicle 112 can travel before needing its battery 110 recharged. When in motion, the rotating winding portion 102 and the stationary winding portion 104 would create an electric field, like a generator, allowing for the device 100 to produce electricity for the battery 110. In this manner, the vehicle 112 would be constantly charging while in motion, thus increasing range and eliminating the time needed to charge the vehicle 112 at home or on the road.

Generally, for the most part, details regarding basic automotive engineering, electrical generators, magnets, electromagnets, coils, stators, rotators, batteries, and the like have been omitted inasmuch as such details are not considered necessary to obtain a complete understanding of the present invention, and are considered to be within the skills of persons of ordinary skill in the relevant art.

As shown in FIG. 2, the battery charging wheels device 100 utilizes rotating 102 and stationary 104 winding portions to charge a battery 110 of an electric vehicle 112. The rotating 102 and stationary 104 winding portions are dynamic and generate power via wheel rotation of the electric vehicle 112. Specifically, the rotating 102 and stationary 104 winding portions operate by the motion of a vehicle 112. The rotating 102 and stationary 104 winding portions operate as a typical generator to create an electric field, allowing for the device 100 to produce electricity for the battery 110.

Further, the rotating winding portion 102 is located on a vehicle wheel 114, at an interior 116 of the wheel 114 and contacts the wheel 114, such that rotation of the wheel 114 causes rotation of the rotating winding portion 102. Typically, the rotating winding portion 102 is comprised of copper windings 118 to efficiently create the electric field when rotating. Further, the corresponding stationary winding portion 104 is located on the vehicle axle 120, typically on an end 121 of the axle 120. The stationary winding portion 104 would comprise a plurality of magnets 122 integrated into it. In use, the rotating winding portion 102 would fit around the stationary winding portion 104, such that the rotating winding portion 102 rotates around the stationary winding portion 104 to create the electric field. Thus, the rotating winding portion 102 is rotated by the vehicle wheel 114, such that as the vehicle wheel 114 rotates, the rotating winding portion 102 rotates around the stationary winding portion 104 which has a plurality of integrated magnets 122, to create power/charge, which is then transmitted to the battery 110.

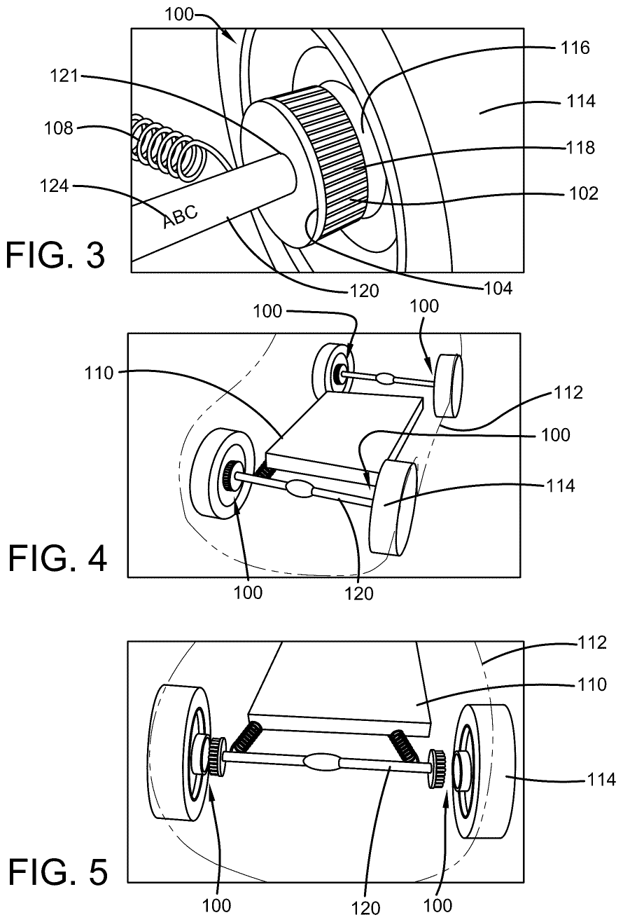

As shown in FIG. 3, the power/charge is transmitted to the battery 110 via a power cable 108 connected from the device 100 to the battery 110. The power/charge created by the device 100 can be transmitted via any suitable transmitting means as is known in the art.

Further, a power supply 106, such as the electric vehicle's motor and drivetrain, act to power the electric vehicle 112 and rotate the wheels 114. Specifically, when in motion, the rotating winding portion 102 and the stationary winding portion 104 would create the electric field, like a generator, allowing for the device 100 to produce electricity for the battery 110.

Additionally, the power from the battery 110 is then transferred to the vehicle's motor to drive/power the vehicle 112. Typically, charge comes into the battery 110 from one side and leaves the battery 110 from the other side. Charge from the battery 110 is then sent via an electrical conduit/power cable 108 to the electric motor to power the vehicle 112.

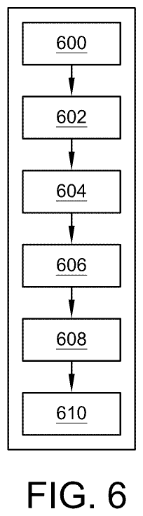

As shown in FIGS. 4-5, in one embodiment, the battery charging wheels device 100 can be secured to two of the four vehicle wheels 114 to provide power to the battery 110. Specifically, the rotating 102 and stationary 104 winding portions would be in communication with the battery 110 to charge it. Typically, an electrical conduit, such as a power cable 108, would transfer the power from the device 100 to the battery 110, to charge it for use.

In another embodiment, the battery charging wheels device 100 can be secured to all four vehicle wheels 114 to provide additional power to the battery 110. When the rotating winding portions 102 are secured to all four wheels 114, they are positioned on an interior wheel 116, and the stationary winding portions 104 are positioned on the wheel axles 120.

Further, the battery charging wheels device 100 then transfers power to the battery 110 for powering the vehicle 112. The battery 110 is charged by the rotating 102 and stationary 104 winding portions, which create an electric field as the wheels 114 rotate during use. In operation, when the electric vehicle 112 moves, the wheels 114 rotate. This rotation causes the rotating winding portion 102 to spin around the stationary winding portion 104 which includes integrated magnets 122, to generate power. This charge/power transmits from the rotating 102 and stationary 104 winding portions through a power cable 108 and to the battery 110, thus recharging the battery 110. In this manner, an electric vehicle 112 is constantly under recharge during the operation of the vehicle 112. Thus, the generation of electricity from the rotating 102 and stationary 104 winding portions result in a decrease in the rate of drain on the electric vehicle's battery 110, thereby increasing the electric vehicle's range, and decreasing the amount of recharge time needed between electric vehicle 112 uses.

In yet another embodiment, the battery charging wheels device 100 comprises a plurality of indicia 124. The winding portions 102, 104 of the device 100 may include advertising, a trademark, or other letters, designs, or characters, printed, painted, stamped, or integrated into the winding portions 102, 104, or any other indicia 124 as is known in the art. Specifically, any suitable indicia 124 as is known in the art can be included, such as, but not limited to, patterns, logos, emblems, images, symbols, designs, letters, words, characters, animals, advertisements, brands, etc., that may or may not be wheel charging, electric vehicle, or brand related.

It may be appreciated that the generation of electricity from the rotating 102 and stationary 104 winding portions result in a decrease in the rate of drain on the electric vehicle's battery 110, thereby increasing the electric vehicle's range, and decreasing the amount of recharge time needed between electric vehicle 112 uses. Thus, a user is freed from the problems associated with fossil fuels without being subjected to the traditionally long charge times, short ranges, and expensive home infrastructure usually associated with electric vehicles 112.

FIG. 6 illustrates a flowchart of the method of charging an electric vehicle via wheel rotation. The method includes the steps of at 600, providing a battery charging wheels device comprising a rotating winding portion and a stationary winding portion. The method also comprises at 602, securing the rotating winding portion to a vehicle wheel. Further, the method comprises at 604, securing the stationary winding portion to a vehicle axle. The method also comprises at 606, fitting the rotating winding portion around the stationary winding portion, such that rotation creates an electric field. The method comprises at 608, transferring the power from the winding portions to a vehicle battery via a power cable connected to the battery to charge the battery. Finally, the method comprises at 610, generating power for the electric vehicle via rotation of the vehicle wheels.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “battery charging wheels device”, “charging wheels device”, and “device” are interchangeable and refer to the battery charging wheels device 100 of the present invention.

Notwithstanding the foregoing, the battery charging wheels device 100 of the present invention can be of any suitable size and configuration as is known in the art without affecting the overall concept of the invention, provided that it accomplishes the above-stated objectives. One of ordinary skill in the art will appreciate that the battery charging wheels device 100 as shown in FIGS. 1-6 is for illustrative purposes only, and that many other sizes and shapes of the battery charging wheels device 100 are well within the scope of the present disclosure. Although the dimensions of the battery charging wheels device 100 are important design parameters for user convenience, the battery charging wheels device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A battery charging wheels device that provides a user with a supplemental charging device for an electric vehicle, the battery charging wheels device comprising:
a rotating winding portion;
a stationary winding portion; and
a battery;
wherein the rotating winding portion is secured to an electric vehicle wheel and the stationary winding portion is secured to an electric vehicle axle;
wherein the rotating winding portion and the stationary winding portion create an electric field;
wherein power generated from the rotating winding portion and the stationary winding portion is transmitted to the battery to charge the battery; and
further wherein the rotating winding portion and the stationary winding portion generate power via wheel rotation of an electric vehicle.

2. The battery charging wheels device of claim 1, wherein the rotating winding portion is located on the electric vehicle wheel, at an interior of the electric vehicle wheel and contacts the electric wheel, such that rotation of the electric vehicle wheel causes rotation of the rotating winding portion.

3. The battery charging wheels device of claim 2, wherein the rotating winding portion is comprised of copper windings to efficiently create the electric field when rotating.

4. The battery charging wheels device of claim 3, wherein the stationary winding portion is located at an end of the electric vehicle axle.

5. The battery charging wheels device of claim 4, wherein the stationary winding portion comprises a plurality of integrated magnets.

6. The battery charging wheels device of claim 5, wherein in use, the rotating winding portion would fit around the stationary winding portion, such that the rotating winding portion rotates around the stationary winding portion to create the electric field.

7. The battery charging wheels device of claim 6, wherein the rotating winding portion is rotated by the electric vehicle wheel, such that as the electric vehicle wheel rotates, the rotating winding portion rotates around the plurality of integrated magnets, to create power, which is then transmitted to the battery.

8. The battery charging wheels device of claim 7, wherein the power is transmitted to the battery via a power cable connected from the battery charging wheels device to the battery.

9. The battery charging wheels device of claim 8, wherein a power supply, such as an electric vehicle's motor and drivetrain act to power the electric vehicle and rotate the electric vehicle wheels.

10. The battery charging wheels device of claim 9, wherein the battery charging wheels device is secured to two of the four electric vehicle wheels to provide power to the battery.

11. The battery charging wheels device of claim 10, wherein the battery charging wheels device is secured to all four vehicle wheels to provide additional power to the battery.

12. A battery charging wheels device that provides a user with a supplemental charging device for an electric vehicle, the battery charging wheels device comprising:
a rotating winding portion located on the electric vehicle wheel, at an interior of the electric vehicle wheel and contacts the electric wheel, such that rotation of the electric vehicle wheel causes rotation of the rotating winding portion;
a stationary winding portion located on the electric vehicle axle; and
a battery;
wherein the rotating winding portion is comprised of copper windings to efficiently create an electric field when rotating;
wherein the stationary winding portion comprises a plurality of integrated magnets;
wherein in use, the rotating winding portion would fit around the stationary winding portion, such that the rotating winding portion rotates around the stationary winding portion to create the electric field;
wherein the rotating winding portion is rotated by the electric vehicle wheel, such that as the electric vehicle wheel rotates, the rotating winding portion rotates around the plurality of integrated magnets, to create power, which is then transmitted to the battery to charge the battery;
wherein the power is transmitted to the battery via a power cable connected from the battery charging wheels device to the battery; and
further wherein the rotating winding portion and the stationary winding portion generate power via wheel rotation of an electric vehicle.

13. The battery charging wheels device of claim 12, wherein the battery charging wheels device is secured to two of the four electric vehicle wheels to provide power to the battery.

14. The battery charging wheels device of claim 12, wherein the battery charging wheels device is secured to all four vehicle wheels to provide additional power to the battery.

15. The battery charging wheels device of claim 12 further comprising a plurality of indicia.

16. The battery charging wheels device of claim 12, wherein a power supply, such as an electric vehicle's motor and drivetrain act to power the electric vehicle and rotate the electric vehicle wheels.

17. The battery charging wheels device of claim 12, wherein the power from the battery is then transferred to the electric vehicle's motor to power the electric vehicle, wherein charge comes into the battery from one side and leaves the battery from the other side.

18. The battery charging wheels device of claim 15, wherein charge from the battery is then sent via a power cable to the electric motor to power the electric vehicle.

19. The battery charging wheels device of claim 12, wherein generation of electricity from the rotating and stationary winding portions result in a decrease in rate of drain on the electric vehicle's battery, thereby increasing the electric vehicle's range, and decreasing the amount of recharge time needed between electric vehicle uses.

20. A method of charging an electric vehicle via wheel rotation, the method comprising the following steps:
providing a battery charging wheels device comprising a rotating winding portion and a stationary winding portion;
securing the rotating winding portion to a vehicle wheel;
securing the stationary winding portion to a vehicle axle;
fitting the rotating winding portion around the stationary winding portion, such that rotation creates an electric field;
transferring the power from the winding portions to a vehicle battery via a power cable connected to the battery to charge the battery; and
generating power for the electric vehicle via rotation of the vehicle wheels.
